(19) United States
(12) Patent Application Publication
(10) Pub. No.: US 2016/0153619 A1
(43) Pub. Date: Jun. 2, 2016

(54) LED WHITE LIGHT LUMINAIRE

(71) Applicant: ZUMTOBEL LIGHTING GMBH, Dornbirn (AT)

(72) Inventor: Anja FROHNAPFEL, Dornbirn (AT)

(21) Appl. No.: 14/904,092

(22) PCT Filed: Jul. 8, 2014
(86) PCT No.: PCT/EP2014/064589

§ 371 Date: Jan. 9, 2016

(30) Foreign Application Priority Data
Jul. 12, 2013 (DE) 10 2013 213 659.5

(51) Int. Cl. F21K 99/00; F21V 7/04; F21V 5/04; H05B 33/08; F21V 23/00

(52) U.S. Cl. CPC F21K 9/30; H05B 33/0845; F21V 23/005; F21V 5/04; F21V 7/041; F21Y 2101/02; F21Y 2113/005

(57) ABSTRACT

A luminaire for emitting an electro-magnetic radiation, having a first LED radiation source for generating a first portion (L) of the radiation in the form of a white light is disclosed. The luminaire further has a second LED radiation source for generating a second portion (UV) of the radiation, wherein the second portion (UV) only has radiation of wavelengths within the wavelength range of about 280 nm to about 425 nm. The second portion (UV) makes it particularly possible that optical brighteners such as occur in white products, for example, can unfold their effect, at least significantly better, such that as a result, the product appears in a “purer” white.

The invention relates to a luminaire for emitting an electromagnetic radiation comprising an LED radiation source (LED: light emitting diode) for generating a white light.

Such a luminaire in the form of an LED emitter is known from the prior art. If such an LED emitter is used for illuminating white products, it can happen that the white does not appear to be “purely” white, but rather has a slight color cast, for example a slight yellow cast. This phenomenon typically occurs if the LED emitter is used for illuminating white substances, white paper and the like.

The reason for this is that optical brighteners, such as may be present for example in white textiles, papers, plastics, inter alia, upon irradiation with the light from the LED emitter, cannot take effect or at least can only take effect in a greatly restricted manner. Optical brighteners require for their effect an electromagnetic radiation from a wavelength range which is approximately between 280 nm and 425 nm, that is to say in particular also includes the UV range. (The transition from ultraviolet radiation to the visible range is at approximately 380 nm.) The customary LED light sources contain practically no UV portion, with the result that they can scarcely excite optical brighteners and the effect described above is caused in this way.

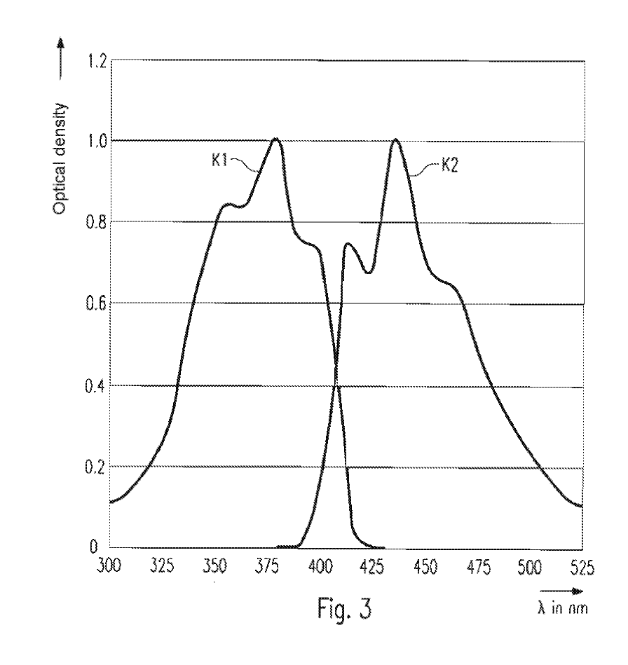

For more extensive illustration of the underlying relationships, FIG. 3 shows a diagram in which the wavelength λ of the electromagnetic radiation is plotted on the abscissa. The absorption spectrum of a typical brightener is schematically depicted by a curve K1. This spectrum extends approximately up to a wavelength of approximately 425 nm and has a maximum at approximately 375 nm. Furthermore, a further curve K2 is shown, showing the corresponding emission spectrum of the brightener. The reason for this shift in the spectrum is fluorescence. The emitted spectrum has a maximum at approximately 437 nm and very predominantly corresponds to a violet-blue light. The blue portion of the radiation which emerges from the correspondingly irradiated white product is therefore increased by this emission spectrum. This ultimately achieves the effect that the white appears to be “purer” or to have less of a yellow cast. Hereinafter, this effect is also referred to as “excitation” of the optical brightener.

The invention is based on the object of specifying a correspondingly improved luminaire. In particular, the luminaire is intended to be particularly well suited to illuminating white articles.

This object is achieved according to the invention by means of the subject matter mentioned in the independent claim. Particular embodiments of the invention are specified in the dependent claims.

The invention provides a luminaire for emitting an electromagnetic radiation, comprising a first LED radiation source for generating a first portion of the radiation in the form of a white light. Furthermore, the luminaire comprises a second LED radiation source for generating a second portion of the radiation, wherein the second portion only has radiation having wavelengths within the wavelength range of approximately 280 nm to approximately 425 nm.

The second portion makes it possible, in particular, that optical brighteners such as occur in white products, for example, can manifest their effect, at least can manifest their effect significantly better, such that the product consequently appears in a “purer” white.

Preferably, the luminaire is fashioned in such away that the electromagnetic radiation which the luminaire is designed to emit is composed only of the first portion and second portion. The ratio between the two portions mentioned can be defined particularly well in this way.

Preferably, the second portion only has radiation having wavelengths within the wavelength range of approximately 280 nm to approximately 400 nm, particularly preferably of approximately 280 nm to approximately 380 nm. By way of example, the second portion can be between approximately 370 nm and approximately 380 nm. Since the absorption maximum of optical brighteners lies in this range, an excitation of the optical brighteners can be achieved energetically particularly advantageously in this way. Moreover, what is achieved in this way is that the color appearance of the light emitted overall by the luminaire is practically not adversely affected by the second portion. In this case, the “color locus” of the light emitted by the luminaire experiences—as viewed on a standard chromaticity diagram—practically no “color shift” as a result of the second portion. In practice, LEDs which emit light having a wavelength of approximately 385 nm are preferably used at the present time. Such LEDs are readily available and can accordingly be used cost-effectively for the purposes of the present invention.

Preferably, the luminaire furthermore comprises a control unit for driving the first LED radiation source and the second LED radiation source, wherein the control unit is fashioned in such a way that the intensity of the first portion is greater than zero if the intensity of the second portion is greater than zero.

If the first portion is greater than zero, the luminaire emits light; this generally has the consequence that an observer of the luminaire—owing to the glare associated therewith—does not look directly into the light emission region of the luminaire. Therefore, the risk of damage to the observer's eyes resulting from UV radiation can be reduced if the control unit is fashioned such that UV radiation is emitted by the luminaire only if the luminaire actually emits light.

In this case, the control unit is preferably furthermore fashioned in such a way that the intensity of the second portion can assume at most a maximum value which is dependent on the intensity of the first portion, in particular is proportional to the latter.

As the intensity of the light emitted by the luminaire increases, the probability that an observer will look directly into the luminaire increases. Since the risk of possible eye damage increases with the intensity of the UV radiation, the risk of damage to the observer's eyes resulting from UV radiation is therefore reduced more extensively by this configuration of the control unit. In this case, the maximum value is chosen, in particular, in such a way that the upper limit for the UV portion as specified in the corresponding standard concerning the so-called photobiological safety of lamps and lamp systems is not exceeded.

In this case, the control unit is furthermore preferably fashioned in such a way that the intensity of the second portion is adjustable up to the maximum value, preferably with the intensity of the first portion being kept constant. This possibility of adjustment has the consequence that the luminaire—for a certain light emission—can be operated with a more or less intensive second portion or UV portion. If the LED luminaire is used for example for illuminating colored articles, it is generally advantageous to regulate the second portion downwards, that is to say to reduce the intensity of the second portion.

In this way, it is possible to avoid or at least reduce a possible color corruption during irradiation or illumination of colored surfaces on account of the second portion. Consequently, the luminaire is particularly well suited firstly to the irradiation of white articles, but secondly also to the irradiation of colored articles.

Preferably, the luminaire is fashioned such that the intensity of the second portion is adjustable in a continuously variable manner up to the maximum value, for example with the aid of a potentiometer. In this way, practically arbitrarily accurately corresponding transition conditions can be achieved, in which case, as an alternative thereto, an adjustment of the second portion in steps would also be conceivable.

Preferably, the control unit is furthermore fashioned in such a way that the intensity of the second portion is adjustable down to the value zero or can be switched off. As a result, the luminaire is also particularly well suited to irradiating colored surfaces.

Preferably, the luminaire furthermore comprises at least one optical element for influencing a radiation emitted by the first LED radiation source and the second LED radiation source, wherein the at least one optical element has, with respect to the spectrum of the second portion, a transmissivity which is at least 60%, preferably at least 70%. In this way, the radiation emitted by the luminaire can be influenced, without the second portion being significantly attenuated by the at least one optical element.

If the luminaire is fashioned in the form of an emitter, it is particularly suited to illuminating products in stores and the like.

The invention is explained in greater detail below on the basis of an exemplary embodiment and with reference to the drawings, in which:

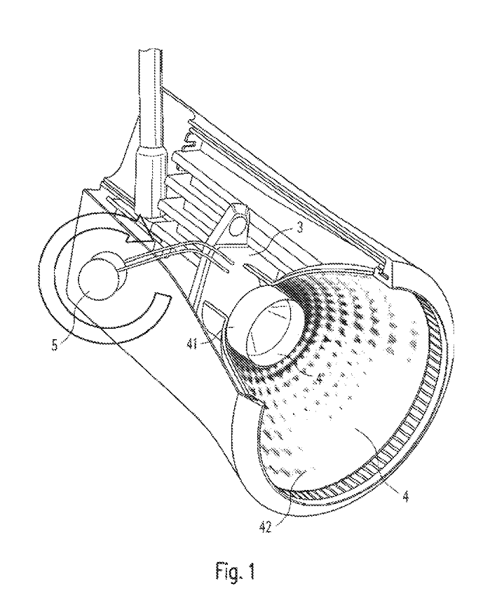

FIG. 1 shows a perspective diagram of an LED luminaire according to the invention,

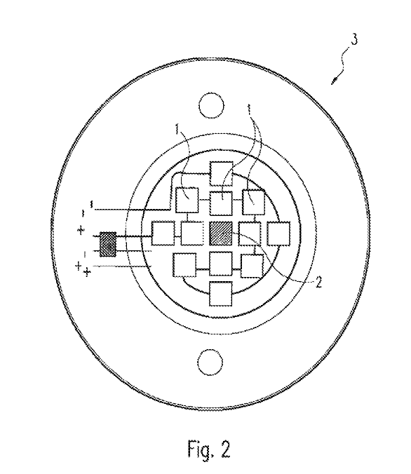

FIG. 2 shows a schematic diagram of a circuit board of the luminaire with the first LED radiation source and second LED radiation source arranged thereon, and

FIG. 3 shows a diagram concerning the absorption and emission behavior of an optical brightener.

FIG. 1 schematically shows—partly in cut-away view—an LED luminaire according to the invention in the form of an LED emitter. The LED luminaire—also referred to hereinafter as luminaire for short—is designed for emitting an electromagnetic radiation.

The luminaire preferably comprises at least one circuit board 3, such as is illustrated separately again highly schematically in FIG. 2.

The luminaire comprises a first LED radiation source 1 for generating a first portion L of the electromagnetic radiation which the luminaire is designed to emit. The first portion L is a white light. The first LED radiation source 1 can comprise or consist of a plurality of individual LEDs as indicated by way of example in FIG. 2. Said LEDs of the first LED radiation source 1 can be white light LEDs known per se, that is to say for example LEDs which generate blue light which is then partly converted into yellow light by a color converting material, with the result that light which appears white overall is emitted, and/or RGB LEDs.

Furthermore, the luminaire comprises a second LED radiation source 2 for generating a second portion UV of the radiation which the luminaire is designed to emit. The second portion UV exclusively comprises radiation having wavelengths within the wavelength range of approximately 280 nm to approximately 425 nm. In this case, the second portion UV can consist, in particular, of radiation which is only in the ultraviolet range of the radiation, in particular in the wavelength interval of approximately 280 nm to approximately 380 nm. The reference sign UV for the second portion is chosen to be reminiscent of this relationship. In this case, “approximately” in association with a wavelength indication is intended to mean a small wavelength range, which can mean for example ±20 nm or ±30 nm.

If the LED luminaire illuminates a white article comprising an optical brightener, the latter emits blue light, as a result of which the article appears to be particularly purely white.

Preferably, the luminaire is fashioned in such a way that the electromagnetic radiation which the luminaire is designed to emit is composed only of the first portion L and second portion UV.

Preferably, the second portion UV only has radiation having wavelengths within the wavelength range of approximately 280 nm to approximately 400 nm, particularly preferably of approximately 280 nm to approximately 380 nm. By way of example, the second portion can be between approximately 370 nm and approximately 380 nm. In particular, the second LED radiation source 2 can be fashioned such that the second portion UV has a maximum at a wavelength which is in the range of 280 nm to 380 nm, particularly preferably in the range of 370 nm to 380 nm. If the second LED radiation source 2 is fashioned such that it emits radiation having a wavelength spectrum which has a maximum at approximately 375 nm, for example at 375 nm ±15 nm, then—on account of the initially described absorption spectrum of a typical brightener as depicted in FIG. 3—the optical brightener can be excited with a comparatively low intensity, such that the luminaire overall can be fashioned with particularly. good efficiency.

Moreover, it is advantageous if the wavelength maximum of the second portion UV is less than 400 nm, particularly preferably less than 380 nm, because in this case the color locus of the light emitted by the luminaire is altered to a particularly small extent by the second portion UV. However, since primarily LEDs which emit light having a wavelength of approximately 385 nm are available at the present time, these LEDs are used for cost reasons at the present time, even if the light from said LEDs, with regard to its wavelength, is just outside the particularly preferred range.

As indicated in FIGS. 1 and 2, provision can be made for the first LED radiation source 1 and the second LED radiation source 2 to be arranged on the at least one circuit board 4.

The second LED radiation source 2 can comprise just one LED for example as shown by way of example in FIG. 2—but in general it can also consist of a plurality of LEDs. Preferably, the second LED radiation source 2 consists of fewer LEDs than the first LED radiation source 1 because, for the excitation of the optical brighteners, it generally suffices if the second portion UV is lower in comparison with the first portion L.

Preferably, the luminaire furthermore comprises a control unit for driving the first LED radiation source 1 and the second LED radiation source 2, wherein the control unit is fashioned in such a way that the intensity of the first portion L is greater than zero if the intensity of the second portion UV is greater than zero. What is achieved in this way is that light is emitted by the luminaire at any rate if the luminaire also emits UV radiation. If an observer observes the luminaire, said observer usually does not look directly into the luminaire when the latter emits light. The control unit fashioned as described makes it possible to rule out a situation in which the observer looks into the luminaire and the latter does not emit light but emits UV radiation. Consequently, the risk of damage to the observer's eyes resulting from UV radiation is at any rate significantly reduced or practically ruled out.

In this case, the control unit is preferably furthermore fashioned in such a way that the intensity of the second portion UV can assume at most a maximum value UV max which is dependent on the intensity of the first portion L, in particular is proportional to the latter. For example, a bypass circuit can be used for this purpose. In this way, the risk of damage to the eyes resulting from UV radiation can be reduced even more extensively. The luminaire can thus be fashioned with particularly high photobiological safety or it can be ensured that the upper limit specified in the standard concerning the photobiological safety of lamps and lamp systems is on no account exceeded.

Accordingly, the luminaire is advantageously fashioned such that it has a light emission area via which both the first portion L and the second portion UV of the radiation are emitted. In this case, a particularly advantageous design is made possible if the first LED radiation source 1 and the second radiation source 2 are arranged. adjacently on the at least one circuit board 3. In particular as revealed in FIG. 2 by way of example—provision can be made for the second LED radiation source 2 to be surrounded by the first LED radiation source 1 in a ring-shaped manner.

Preferably, the luminaire furthermore comprises at least one optical element 4 for influencing the radiation emitted by the two LED radiation sources 1, 2. By way of example, the at least one optical element 4 can comprise a lens 41 and/or a reflector 42. Preferably, the at least one optical element 4 is fashioned such that, with respect to the spectrum of the second portion UV it is transmissive to the extent of at least 60%, particularly preferably to the extent of at least 70%. This is energetically advantageous with respect to the effect of interest here. Accordingly, by way of example, the lens 41 can have a transmittance for the second portion UV that is greater than 60%, preferably greater than 70%.

In the example shown, the lens 41 is fashioned as a primary optical element, and the reflector 42 as a secondary optical element. The reflector 42 is shaped as a cone section to a first approximation, and the light emission area of the luminaire is defined by the larger opening thus formed.

The luminaire is furthermore preferably fashioned such that the first portion L generated by the first LED radiation source 1 and the second portion UV generated by the second LED radiation source 2 only passed through the at least one optical element 4 before leaving the luminaire toward the outside. A further attenuation of the second portion UV can be avoided as a result.

In this case, the control unit is furthermore preferably fashioned in such a way that the intensity of the second portion UV is adjustable up to the maximum value UVmax, preferably with the intensity of the first portion L being kept constant. In particular, in this case the luminaire can be fashioned such that the intensity of the second portion UV is adjustable in a continuously variable manner up to the maximum value UVmax, for example with the aid of a potentiometer 5, in which case, of course, a variation of the UV portion in small steps would also he conceivable. Advantageously, the luminaire is fashioned such that the potentiometer 5 can be adjusted on the luminaire from outside, that is to say that, for example, a corresponding rotary regulator is arranged on the exterior of the housing of the luminaire, as indicated by way of example in FIG. 1.

In this way, the intensity of the second portion UV can be reduced, for example reduced to zero, which makes it possible to achieve the effect, in particular, that the colors are not corrupted by a second portion UV when colored articles are illuminated. Consequently, the luminaire is suitable firstly for irradiating or illuminating white articles, but secondly also for irradiating colored articles. Accordingly, the design is furthermore preferably such that the intensity of the second portion UV is adjustable down to the value zero or can be switched off. As a result, the luminaire is also particularly well suited to irradiating colored surfaces.

1. A luminaire for emitting an electromagnetic radiation, comprising:
a first LED radiation source for generating a first portion (L) of the radiation in the form of a white light, and
a second LED radiation source for generating a second portion (UV) of the radiation, wherein the second portion (UV) only has radiation having wavelengths within the wavelength range of approximately 280 nm to approximately 425 nm.

2. The luminaire as claimed in claim 1, which is fashioned in such a way that the electromagnetic radiation which the luminaire is designed to emit is composed only of the first portion (L) and second portion (UV).

3. The luminaire as claimed in claim 1, wherein the second portion (UV) only has radiation having wavelengths within the wavelength range of approximately 280 nm to approximately 400 nm, preferably of approximately 280 nm to approximately 380 nm.

4. The luminaire as claimed in claim 1, furthermore comprising:
a control unit for driving the first LED radiation source and the second LED radiation source, wherein the control unit is fashioned in such a way that the intensity of the first portion (L) is greater than zero if the intensity of the second portion (UV) is greater than zero.

5. The luminaire as claimed in claim 4, wherein the control unit is fashioned in such a way that the intensity of the second portion (UV) can assume at most a maximum value (UVmax) which is dependent on the intensity of the first portion (L), in particular is proportional to the latter.

6. The luminaire as claimed in claim 5, wherein the control unit is furthermore fashioned in such a way that the intensity of the second portion (UV) is adjustable up to the maximum value (UVmax), preferably with the intensity of the first portion (L) being kept constant.

7. The luminaire as claimed in claim 6, wherein the intensity of the second portion (UV) is adjustable in a continuously variable manner up to the maximum value (UVmax), for example with the aid of a potentiometer.

8. The luminaire as claimed in claim 4, wherein the control unit is furthermore fashioned in such a way that the intensity of the second portion (UV) is adjustable down to the value zero or can be switched off.

9. The luminaire as claimed in claim 1, furthermore comprising:
at least one optical element for influencing a radiation emitted by the first LED radiation source and the second LED radiation source, wherein the at least one optical element has, with respect to the spectrum of the second portion (UV), a transmissivity which is at least 60%, preferably at least 70%.

10. The luminaire as claimed in claim 1, in the form of an emitter.
